(19) United States
(12) Patent Application Publication
(10) Pub. No.: US 2011/0058770 A1
(43) Pub. Date: Mar. 10, 2011

(54) SUB-SURFACE ENGRAVING OF OLED SUBSTRATES FOR IMPROVED OPTICAL OUTCOUPLING

(75) Inventor: IAN D. PARKER, SANTA BARBARA, CA (US)

(73) Assignee: E. I. DU PONT DE NEMOURS AND COMPANY, Wilmington, DE (US)

(21) Appl. No.: 12/876,301

(22) Filed: Sep. 7, 2010

Related U.S. Application Data
(60) Provisional application No. 61/241,138, filed on Sep. 10, 2009.

(51) Int. Cl. G02B 6/42; B29C 35/08

(52) U.S. Cl. 385/31; 264/400

(57) ABSTRACT

An electronic device includes a radiation-emitting component, a radiation-responsive component, or a combination thereof. In one embodiment, the introduction of scattering sites into a substrate of the radiation emitting electronic device will increase optical outcoupling. In one embodiment, the substrate can be glass or plastic and a laser is used as a sub-surface engraving tool to produce scattering sites.

### RELATED APPLICATION

This application claims priority under 35 U.S.C. §119(e) from Provisional Application No. 61/241,138 filed Sep. 10, 2009, which is incorporated by reference in its entirety.

### FIELD OF THE DISCLOSURE

The invention relates generally to electronic devices and processes, and more specifically to electronic devices having sub-surface engraving of substrates to improve optical outcoupling.

### BACKGROUND INFORMATION

Many electronic devices are designed to emit or respond to radiation. Examples of electronic devices include Organic Light Emitting Diodes (OLEDs). OLEDs are promising for display applications due to their high power conversion efficiency and low processing costs. OLEDs include organic active layers that can emit or respond to the radiation.

A waveguide (also called a “light pipe”) may be formed within an electronic device at an interface between layers having dissimilar refractive indices. The waveguide effect can occur when radiation propagating within a layer having a higher refractive index is reflected at an interface with another layer having a lower refractive index. The waveguide effect can cause radiation to propagate laterally as opposed to propagating towards the user of the electronic device. In electronic devices, the lateral propagation of radiation can reduce the efficiency of the electronic device (require more power for a desired level of intensity), increase optical cross talk between pixels, or a combination thereof. Conventional wisdom within the art is to reduce or eliminate the waveguide effect as much as possible.

### SUMMARY

An electronic device includes a radiation-emitting component, a radiation-responsive component, or a combination thereof. In a first aspect, the electronic device includes a substrate and a first structure overlying the substrate, wherein the first structure is an electrically active structure. A process for producing the electronic device includes a substrate and a sub-surface engraving tool used to etch scattering sites within the substrate at one or more designated locations. The scattering sites improve optical outcoupling for radiation-emitting components. The substrate can be glass, plastic or any substrate material capable of treatment with the sub-surface engraving tool to etch scattering sites within the material. The dimensions of the scattering sites may generally be from 10 to 500 micrometers (1×10⁻⁶ meters, also denoted as μm), or more specifically 20 to 50 μm. The distance between scattering sites is limited only to the extent of a minimum distance between sites to prevent cracking of the substrate, and is dependent upon the substrate material. In one embodiment of a glass substrate, the distance between scattering sites may be a minimum distance of 100 μm. One possible embodiment of the sub-surface engraving tool is a laser, producing scattering sites at uniform or different depths within the substrate material. Laser power can vary widely depending upon the substrate material, but is generally within a range of 0.1 to 5 millijoules (1×10⁻³ Joules, also denoted as mJ), or more specifically 1 to 5 mJ. In one embodiment the laser is non-continuous, having a pulsed operation with a pulse duration of from 1 to 100 nanoseconds (1×10⁻⁹ seconds, also denoted as nsec.).

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes an illustration showing how radiation from an organic light emission layer may propagate through different layers within an electronic device.

FIG. 2 includes an illustration of an OLED device with percentages associated with the three primary loss mechanisms.

FIG. 3 includes an illustration of various options for scattering sites within a substrate.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

An electronic device includes a radiation-emitting component, a radiation-responsive component, or a combination thereof. In a first aspect, the electronic device includes a substrate and a first structure overlying the substrate, wherein the first structure is an electrically active structure. In one embodiment the electronic device is an OLED device to generate light. Only a small portion of the generated light escapes the OLED device to be detected by a user of the OLED device. In some instances up to 75% of the generated light is trapped with the substrate and associated layers, or is dissipated as heat within the OLED device. The loss mechanisms for this generated light can be characterized in three categories: dissipation of electromagnetic energy through excitation of surface-plasmons in a metallic electrode, light trapped and waveguided in the organic indium tin-oxide (ITO) layers, and light trapped and waveguided in the substrate. The present aspects address a method and device for reclaiming a portion of the light trapped and waveguided in the substrate, the third category of loss mechanisms.

Previous attempts to address loss mechanisms include insertion of low refractive-index layer between electrode and substrate, or insertion of a scattering layer on the surface of the substrate adjacent the electrode. Application of geometric structures to the front surface of the electronic device includes microprisms or microlenses.

Modification of the internal portions of the substrate with a sub-surface engraving tool allows scattering sites to be etched at locations within the substrate. This process permits more light to leave the substrate, also referred to as outcoupling. In one embodiment the sub-surface engraving tool is a laser with sufficient power to fracture, or melt, an area within the substrate to produce the scattering sites. Non-limiting examples of the type of laser employed include the ST-C1 and ST-C2 from Sintec Optronics. Location of the scattering sites may be at a fixed depth within the substrate or at various levels within the substrate. Placement of the scattering sites can provide increased outcoupling for each individual color of the OLED device, or intentionally blend the colors of the OLED device to produce desired wavelengths, such as white light.

In a further embodiment of the first aspect, the first structure includes a first layer as an electrode for the electronic device. In another further embodiment, a second layer includes an organic active layer. In still another further embodiment, the electronic device includes a display, wherein the first layer and the second layer lie within an array of the display.

Other features and advantages of the invention will be apparent from the following detailed description, and from the claims. The detailed description first addresses Definitions and Clarification of Terms followed by Refraction, Reflection, and Waveguides, Fabrication Process, Device Operation, Other Embodiments.

### 1. DEFINITIONS AND CLARIFICATION OF TERMS

Before addressing details of embodiments described below, some terms are defined or clarified.

The term “active” when referring to a layer or material is intended to mean a layer or material that exhibits electro-radiative or electro-magnetic properties. An active layer material may emit radiation or exhibit a change in concentration of electron-hole pairs when receiving radiation.

The term “charge-blocking,” when referring to a layer, material, member, or structure, is intended to mean such layer, material, member or structure reduces the likelihood that a charge migrates into another layer, material, member or structure.

The term “charge carrier,” with respect to an electronic component or circuit, is intended to mean the smallest unit of charge. Charge carriers can include n-type charge carriers (e.g., electrons or negatively charged ions), p-type charge carriers (e.g., holes or positively charged ions), or any combination thereof.

The term “charge-injecting,” when referring to a layer, material, member, or structure, is intended to mean such layer, material, member or structure promotes charge migration into an adjacent layer, material, member or structure.

The term “charge-transport,” when referring to a layer, material, member, or structure is intended to mean such layer, material, member, or structure facilitates migration of such charge through the thickness of such layer, material, member, or structure with relative efficiency and small loss of charge. [see “electron transport”, “hole transport.”]

The term “electrically active structure” is intended to mean a structure within a radiation-emitting component, a radiation-responsive component, or a combination thereof, wherein such structure is designed such that a significant amount of charge carriers flow through, into, or out of such structure during normal operation of such radiation-emitting component, radiation-responsive component, or combination thereof. An example of an electrically active structure includes an anode, a cathode, a portion of an organic active layer, a buffer layer, a charge-blocking layer, a charge-injecting layer, a charge-transport layer, or any combination thereof.

The term “layer” refers to a film covering a desired area. The area can be as large as an entire display, or as small as a specific functional area, such as a single sub-pixel. A layer can be made from one or more organic or inorganic materials or mixtures thereof.

The term “organic active layer” is intended to mean one or more organic layers, wherein at least one of the organic layers, by itself, or when in contact with a dissimilar material is capable of forming a rectifying junction.

The term “precision deposition technique” is intended to mean a deposition technique that is capable of depositing one or more materials over a substrate at a dimension, as seen from a plan of the substrate, no greater than approximately one millimeter. A stencil mask, frame, well structure, patterned layer or other structure(s) may or may not be present during such deposition.

The term “primary surface” is intended to mean a surface of a substrate from which an electronic device is subsequently formed.

The term “radiation-emitting component” is intended to mean an electronic component, which when properly biased, emits radiation at a targeted wavelength or spectrum of wavelengths. The radiation may be within the visible-light spectrum or outside the visible-light spectrum (ultraviolet (“UV”) or infrared (“IR”)). A light-emitting diode is an example of a radiation-emitting component.

The term “radiation-responsive component” is intended to mean an electronic component can sense or otherwise respond to radiation at a targeted wavelength or spectrum of wavelengths. The radiation may be within the visible-light spectrum or outside the visible-light spectrum (UV or IR). Photodetectors, IR sensors, biosensors, and photovoltaic cells are examples of radiation-responsive components.

The term “substrate” is intended to mean a base material that can be either rigid or flexible and may be include one or more layers of one or more materials, which can include, but are not limited to, glass, polymer, metal or ceramic materials or combinations thereof.

The term “user side” is intended to mean a side of the electronic device principally used during normal operation of the electronic device. In the case of a display, the side of the electronic device seen by a user would be a user side. In the case of a detector or voltaic cell, the user side would be the side that principally receives radiation that is to be detected or converted to electrical energy. Note that an electronic device may have more than one user side.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, for clarity purposes and to give a general sense of the scope of the embodiments described herein, the use of the “a” or “an” are employed to describe one or more articles to which “a” or “an” refers. Therefore, the description should be read to include one or at least one whenever “a” or “an” is used, and the singular also includes the plural unless it is clear that the contrary is meant otherwise.

Group numbers corresponding to columns within the Periodic Table of the elements use the “New Notation” convention as seen in the CRC Handbook of Chemistry and Physics, 81^{st} Edition (2000).

Unless otherwise defined, all technical and scientific terms used herein have the same meaning as commonly understood by one of ordinary skill in the art to which this invention belongs. Although suitable methods and materials are described herein for embodiments of the invention, or methods for making or using the same, other methods and materials similar or equivalent to those described can be used without departing from the scope of the invention. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

To the extent not described herein, many details regarding specific materials, processing acts, and circuits are conventional and may be found in textbooks and other sources within the organic light-emitting diode display, photodetector, photovoltaic, and semiconductor arts.

### 2. REFRACTION, REFLECTION, AND WAVEGUIDES

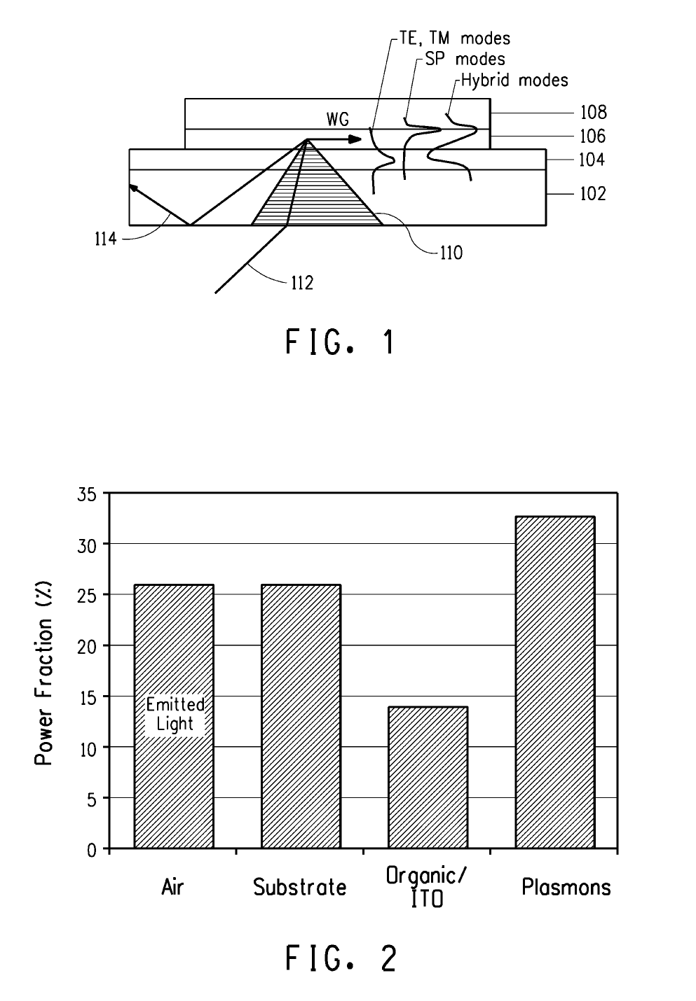

The waveguide effect is better understood with respect to FIG. 1. While the discussion of FIG. 1 is directed to light, other types of radiation may have similar effects. An electronic device 100 is depicted in FIG. 1, with substrate 102, an ITO electrode as first layer 104, an organic active layer 106 as a second layer and a cathode 108. An escape cone 110 is shown to depict the range of light 112 to escape the substrate 102. Light trapped within the substrate 102 is denoted at 114.

Radiation is emitted in a plurality of directions from the organic active layer 106. At the interfaces of 102, 104, 106 and 108 radiation may pass from one layer into another, be reflected at the interface, or both. Because the cathode 108 is a mirror, essentially all light reaching the surface of cathode 108 is reflected. Whether any or all of the radiation is reflected depends on the refractive indices of the layers at the interface and the incident angle of the radiation, which is the approach angle for the radiation as measured from a line perpendicular to the interface. Referring to FIG. 1, an incident angle of 0° corresponds to radiation propagating in a direction along a vertical axis. If the incident angle is larger than a critical angle, at least some of the radiation is reflected at the interface. If the incident angle is the same or less than the critical angle, substantially all of the radiation passes through the interface. The critical angle (θ_{c}) is given by Equation 1.

θ_{c}=sin⁻¹(η₂/η₁) Equation 1

wherein:

η₁ is the refractive index of a first layer or material in which the radiation is propagating; and

η₂ is the refractive index of a second layer or material lying on the other side of the interface of the first layer or material.

Radiation 112 and 114 are emitted from organic active layer 106, and radiation 114 illustrates the waveguide effect. Radiation 114 reaches air interface of substrate 102, the incident angle is greater than the critical angle. Therefore, some of the radiation is reflected by the interface, as illustrated by radiation 114.

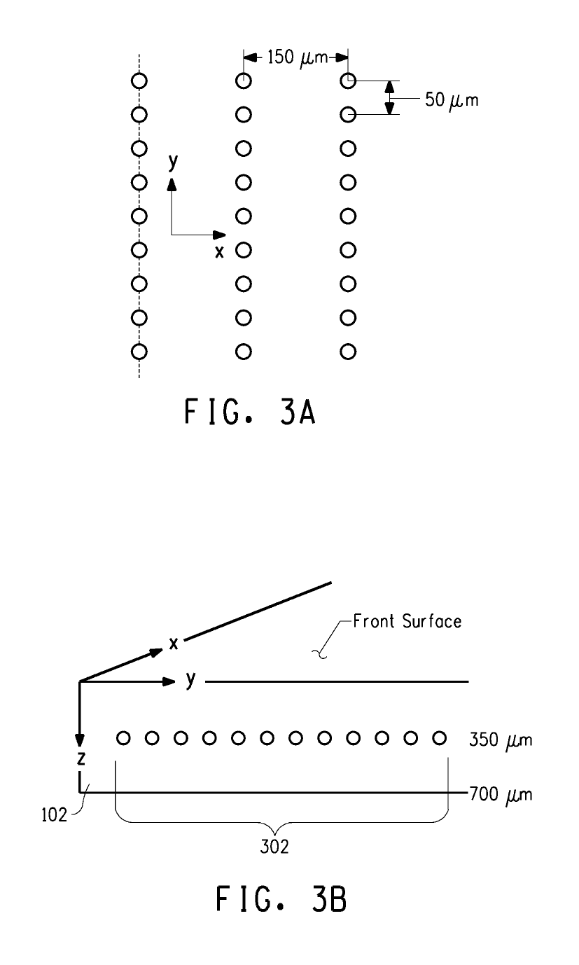

FIG. 2 indicates the percentages associated with the three loss mechanisms, where in one embodiment for a glass substrate, only 25% of the radiation emitted from the organic active layer 106 is actually detected by a user. Note the substrate 102 can consume 25% of the emitted radiation, and any improvement in this loss will add to overall efficiency.

While much of the discussion herein is directed towards radiation-emitting components, similar effects may occur for radiation-responsive components. The use of the designs described herein may be used to increase the effective reception area of a radiation-responsive component without increasing the actual size of the radiation-responsive component.

### 4. FABRICATION PROCESS

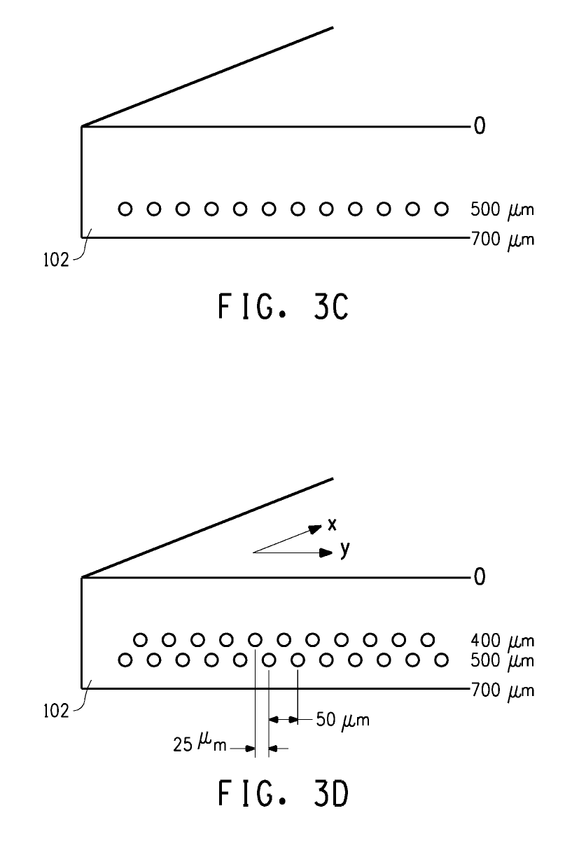

FIG. 3 includes a plan view of a portion of substrate 102. More specifically, FIG. 3 includes various embodiments for placement of scattering sites 302, also referred to as dots. In one embodiment scattering sites 302 are located at a fixed depth within substrate 102, in the illustrated case 350 μm depth of the total thickness of 700 μm. In a second embodiment, scattering sites 302 are shown at the 500 μm level. In a third embodiment the scattering sites 302 are shown at various depths, including 400 μm and 500 μm levels. Peripheral and remote circuitry are not illustrated to simplify the understanding of the invention. Such peripheral and remote circuitry may be formed before formation of the array, during formation of the array, after formation of the array, or any combination thereof. The substrate 102 can include nearly any type and number of materials including organic, inorganic, conductive, semiconductive, or insulating materials. The materials and thicknesses of materials are conventional. If the substrate 102 lies along a user side of the electronic device, the substrate 102 should be capable of transmitting at least 70% of the radiation propagating normal to the surface of the substrate 102 along the user side. Depending on the material(s) selected for the substrate 102, each of the materials may have a refractive index in a range of approximately 1.4 to 1.8. Glass and many types of plastics used in substrates have refractive indices in a range of approximately 1.5 to 1.6.

After reading this specification, skilled artisans appreciate that the selection of material(s) that can be used for the substrate 102 varies widely. After reading this specification, skilled artisans are capable of selecting the appropriate material(s) based on their physical, chemical, and electrical properties. For simplicity, the material(s) used for this base are referred to as substrate 102.

First electrodes 104 may then be formed over a primary surface of the substrate 102 as illustrated in FIG. 1. The first electrodes 104, which are a specific type of electrically active structure, can include nearly any conductive material. In this specific embodiment, the first electrodes 104 act as anodes for the electronic device being formed. In general, the material of the first electrodes 104 has a work function relatively higher than subsequently formed second electrodes 108 that act as the cathodes. A plurality of layers may be formed to create the first electrodes 104. One or more of the layers within the first electrodes 104 can have a refractive index in a range of approximately 1.8 to 3.0. In one particular embodiment, the first electrodes 104 include layers of silicon nitride and ITO. The ITO may have a refractive index of approximately 2.0.

In the embodiment illustrated in FIG. 1, the first electrodes 104 lie between a user side (not shown) of the electronic device 100 and the subsequently formed organic active layer 106. Therefore, first electrodes 104 should be transparent to allow the radiation to be transmitted through the first electrodes 104. Exemplary materials for first electrodes 104 include ITO, zirconium tin oxide (“ZTO”), elemental metals, metal alloys, and combinations thereof. ITO and ZTO may be thicker when used as the first electrodes 104 and still allow sufficient transmission of radiation. For example, when ITO or ZTO are used as the first electrode 104, the first electrodes 104 may have a thickness in a range of approximately 100 to 200 nm.

The organic active layer 106 is formed as illustrated in FIG. 1. The organic active layer 106 may include one or more layers. For example, the organic layer 106 may include a hole-transport layer (not shown). Although not shown, the organic active layer 106 may include an electron-transport layer. It is further understood that organic active layer 106 in organic electronic devices may include a variety of organic materials, such as charge transport materials, anti-quenching materials, a variety of active materials (e.g. light-emitters, photodetectors, IR detectors and other radiation sensitive materials).

The hole-transport layer (not shown) and the organic active layer 106 are formed sequentially over the first electrode 104. Each of the hole-transport layer and the organic active layer 106 can be formed by using a liquid deposition technique to deposit appropriate materials as described below. One or both of the hole-transport layer and the organic active layer 106 may be cured after it is applied. In one embodiment, the organic active layer 106 overlies all of first electrode 104. In this embodiment, a precision deposition technique, such as ink-jet printing or slot die coating, may be used to dispense a small amount of the organic layer, such that the organic active layer 106 is discontinuous between the radiation-emitting components.

In one embodiment, the hole-transport layer can include an organic polymer, such as polyaniline (“PANI”), poly(3,4-ethylenedioxythiophene) (“PEDOT”), or an organic charge transfer compound, such as tetrathiafulvalene tetracyanoquinodimethane (TTF-TCQN). The hole-transport layer typically has a thickness in a range of approximately 100 to 250 nm.

The composition of the organic active layer 106 typically depends upon the application of the electronic device. When the organic active layer 106 is used in a radiation-emitting electronic device, the material(s) of the organic active layer 106 will emit radiation when sufficient bias voltage is applied to the anode and cathode. The radiation-emitting active layer may contain nearly any organic electroluminescent or other organic radiation-emitting materials.

Such materials can be small molecule materials or polymeric materials. Small molecule materials may include those described in, for example, U.S. Pat. No. 4,356,429 and U.S. Pat. No. 4,539,507. Alternatively, polymeric materials may include those described in U.S. Pat. No. 5,247,190, U.S. Pat. No. 5,408,109, and U.S. Pat. No. 5,317,169. Exemplary materials are semiconducting conjugated polymers. An example of such a polymer is poly (phenylenevinylene) referred to as “PPV.” The light-emitting materials may be dispersed in a matrix of another material, with or without additives, but typically form a layer alone. The organic active layer generally has a thickness in the range of approximately 40 to 100 nm.

When the organic active layer 106 is incorporated into a radiation-responsive electronic device, the material(s) of the organic active layer 106 may include many conjugated polymers and electroluminescent materials. Such materials include for example, many conjugated polymers and electro- and photo-luminescent materials. Specific examples include poly(2-methoxy,5-(2-ethyl-hexyloxy)-1,4-phenylene vinylene) (“MEH-PPV”) and MEH-PPV composites with CN-PPV. The organic active layer 104 typically has a thickness in a range of approximately 50 to 500 nm.

Although not shown, an optional electron-transport layer may be formed over the organic active layer 106. In one specific embodiment, the electron-transport layer can include metal-chelated oxinoid compounds (e.g., Alq₃); phenanthroline-based compounds (e.g., 2,9-dimethyl-4,7-diphenyl-1,10-phenanthroline (“DDPA”), 4,7-diphenyl-1,10-phenanthroline (“DPA”)); azole compounds (e.g., 2-(4-biphenyl)-5-(4-t-butylphenyl)-1,3,4-oxadiazole (“PBD”), 3-(4-biphenyl)-4-phenyl-5-(4-t-butylphenyl)-1,2,4-triazole (“TAZ”); or any one or more combinations thereof. Alternatively, the optional electron-transport layer may be inorganic and include BaO, LiF, or Li₂O. The electron-transport layer typically has a thickness in a range of approximately 30 to 500 nm.

Second electrodes 108 are formed over the organic active layer 106 as shown in FIG. 1. The second electrodes 108 act as cathodes for the electronic device. In one embodiment, the second electrodes 108 can include a metal-containing layer having a low work function, which is lower than the first electrodes 104 that have a high work function. Materials for the second electrodes 108 can be selected from Group 1 metals (e.g., Li, Cs), the Group 2 (alkaline earth) metals, the rare earth metals including the lanthanides and the actinides. The second electrodes 108 have a thickness in a range of approximately 300 to 600 nm. In one specific, non-limiting embodiment, a Ba layer of less than approximately 10 nm followed by an Al layer of approximately 500 nm may be deposited. A stencil mask corresponding to the pattern of the second electrodes 108 can be used with a conventional deposition process, such as evaporation, sputtering, or the like. For simplicity, the second electrodes 108 are considered an optical mirror.

Other circuitry not illustrated in FIG. 1 may be formed using any number of the previously described or additional layers. Although not shown, additional insulating layer(s) and interconnect level(s) may be formed to allow for circuitry in peripheral areas (not shown) that may lie outside the array. Such circuitry may include row or column decoders, strobes (e.g., row array strobe, column array strobe), or sense amplifiers.

An encapsulating layer (not shown) can be formed over the array and the peripheral and remote circuitry to form a substantially completed electrical component, such as an electronic display, a radiation detector, and a voltaic cell. The encapsulating layer may be attached to the substrate 102. Radiation may be transmitted through the encapsulating layer. If so, the encapsulating layer should be transparent to the radiation.

In one embodiment, the electronic device comprises one or more radiation-emitting components, one or more radiation-responsive components, or any combination thereof. Within each of the radiation-emitting component(s) or radiation-responsive components, electrically active structures can include the first electrodes 104, the second electrodes 108, and the organic active layer 106 lying between the first electrodes 104 and second electrodes 108. Charge carriers can flow through the first electrodes 104, second electrodes 108, or both. With respect to the organic active layer 106, for a radiation-emitting component, charge carriers can flow into the organic active layer 106 from the first electrodes 104, second electrode 108, or both, and radiation can be emitted from the organic active layer 106. For a radiation-responsive component, radiation can be received by the organic active layer 106, thus producing charge carriers that can flow from the organic active layer 106 to the first electrodes 104, second electrodes 108, or both. For the purposes of this specification, a thin-film transistor is not considered an electrically active structure because it is not part of a radiation-emitting component (e.g., an OLED) or a radiation-responsive component (e.g., radiation sensor or photovoltaic cell).

### 7. OTHER EMBODIMENTS

In one embodiment, a full-color active matrix display may be formed. Portions of the organic active layer 104 may selectively receive organic dye(s) using an inkjet to allow the different colors within a pixel (a collection of radiation-emitting components) to be realized. Alternatively, different organic active layers may be used for the different radiation-emitting components within a pixel. If an active matrix OLED display is being formed, thin-film circuits may be present with substrate 102. Such thin-film circuits are conventional.

In still other embodiments, the materials used for the first electrodes 104 and second electrodes 108 can be reversed. In this manner, the anodes and cathodes are effectively reversed (cathode closer to the user side rather than the anode). Note that if the cathode lies closer to the user side, it may need to be substantially transparent to radiation emitted or received by the electronic device. Similarly, note that the embodiment described within FIG. 1 may also have the electrodes reversed.

At least some of the embodiments described herein may improve radiation emission characteristics without an increase in size of the radiation-emitting components or power. Additionally, optical cross talk between radiation-emitting components may be reduced. Designs can be achieved that take advantage of the waveguide effect and redirect radiation that may otherwise propagate to other components or outside the viewing area of the display to be emitted within the viewing area of the display. Concepts described herein can be used to potentially create radiation-responsive components that may be more sensitive to radiation. Note that one or more of the advantages are not required for all embodiments.

What is claimed is:

1. A process comprising:
providing a substrate;
providing a sub-surface engraving tool; and
directing the sub-surface engraving tool to etch scattering sites within the substrate at one or more designated locations.

2. The process of claim 1, wherein the substrate is glass.

3. The process of claim 1, wherein the substrate is plastic.

4. The process of claim 2, wherein the sub-surface engraving tool is a laser.

5. The process of claim 4, wherein the scattering sites are located at uniform depth of the substrate.

6. The process of claim 4, wherein the scattering sites are located at various depths of the substrate.

7. The process of claim 4, wherein the laser power is within a range of 0.1 mJ to 5 mJ.

8. The process of claim 4, wherein the laser power is within a range of 1 mJ to 5 mJ.

9. The process of claim 8, wherein the laser pulse duration is from 1 nsec to 100 nsec.

10. The process of claim 4, wherein the scattering sites are between 10 micrometers and 500 micrometers in diameter.

11. The process of claim 4, wherein the scattering sites are between 20 micrometers and 50 micrometers in diameter.

12. The process of claim 11, wherein the distance between scattering sites is greater than 100 micrometers.

13. An electronic device formed by the process of claim 1.

14. An electronic device formed by the process of claim 3.

15. An electronic device formed by the process of claim 12.
